(19) United States
(12) Patent Application Publication
(10) Pub. No.: US 2018/0183899 A1
(43) Pub. Date: Jun. 28, 2018

(54) TRANSPORT AGNOSTIC DISPLAY PROTOCOL

(71) Applicant: Intel Corporation, Santa Clara, CA (US)

(72) Inventors: Nausheen ANSARI, Folsom, CA (US); Srikanth KAMBHATLA, Portland, OR (US); Abdul R. ISMAIL, Beaverton, OR (US); Karthi R. VADIVELU, Folsom, CA (US); John S. HOWARD, Hillsboro, OR (US); Gal YEDIDIA, Haifa (IL); Reuven ROZIC, Binyamina (IL); Paul S. DIEFENBAUGH, Portland, OR (US); Zachary F. HAMM, Folsom, CA (US)

(73) Assignee: Intel Corporation, Santa Clara, CA (US)

(21) Appl. No.: 15/853,624

(22) Filed: Dec. 22, 2017

Related U.S. Application Data
(60) Provisional application No. 62/438,953, filed on Dec. 23, 2016.

(51) Int. Cl. H04L 29/06; G09G 3/20

(52) U.S. Cl. CPC H04L 69/03; G09G 3/2096; G09G 2370/16; G09G 2370/12; H04L 69/24; G09G 2370/10; G09G 2370/047; G09G 2340/02; G09G 2352/00; G09G 2370/042

(57) ABSTRACT

Described is an apparatus comprising a first circuitry and a second circuitry. The first circuitry may be operable to provide output to a unidirectional data path for carrying a packetized data stream. The second circuitry may be operable to provide output to, and obtain input from, a bidirectional control path for carrying a packetized control stream. The packetized data stream may comprise pixel data traffic and frame-synchronous metadata traffic, and the packetized control stream may comprise frame-asynchronous metadata traffic and control traffic.

### CLAIM FOR PRIORITY

The present application claims priority under 35 U.S.C. § 119(e) to U.S. Provisional Patent Application Ser. No. 62/438,953 filed Dec. 23, 2016, which is herein incorporated by reference in its entirety.

### BACKGROUND

Industry standards for video streaming transports (e.g., DisplayPort, embedded DisplayPort, High-Definition Multimedia Interface (HDMI), Mobile Industry Processor Interface (MIPI), and so on) may feature dedicated protocol layers for video transmission built on physical layers (PHYs) and/or transport layers. Video streaming transports may provide dedicated links over which video data may be transmitted from source devices to sink devices.

Meanwhile, video streaming protocols may assume certain PHY and/or transport layer requirements, and a source device may generate a stream that may be limited to being transmitted over a specific transport.

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates an end-to-end flow in devices incorporating Transport Agnostic Display (TAD) mechanisms and methods, in accordance with some embodiments of the disclosure.

FIG. 2 illustrates a layered architecture comprising a TAD source and a TAD sink, in accordance with some embodiments of the disclosure.

FIG. 3 illustrates an apparatus comprising TAD source mechanisms, in accordance with some embodiments of the disclosure.

FIG. 4 illustrates an apparatus comprising TAD sink mechanisms, in accordance with some embodiments of the disclosure.

FIG. 5 illustrates a TAD source method, in accordance with some embodiments of the disclosure.

FIG. 6 illustrates a TAD sink method, in accordance with some embodiments of the disclosure.

FIG. 7 illustrates a computing device with TAD source mechanisms and/or TAD sink mechanisms, in accordance with some embodiments of the disclosure.

### DETAILED DESCRIPTION

Video data may be transmitted over dedicated links from source devices to sink devices, in accordance with various standards-based interfaces (e.g., DisplayPort, embedded DisplayPort, High-Definition Multimedia Interface (HDMI), Mobile Industry Processor Interface (MIPI), and so on). Video streaming protocols may assume certain PHY and/or transport layer requirements, and source devices may generate streams that may be limited to being transmitted over specific transports (which may be protocol-based physical cables, physical connectors, or wireless interface, for example).

Source devices may be disposed to implementing multiple protocols. However, various protocol standards may be subject to transport-specific nuances (e.g., efficiency loss) and user-experience issues, and intermixing of transports may create protocol conversion and/or translation complexities.

Disclosed herein are mechanisms and methods related to Transport Agnostic Display (TAD) video streaming and control protocol. TAD transmissions may advantageously be adapted to run over legacy wired transports previously defined for video streaming (e.g., USB), or legacy wireless transports (e.g., 802.11), or non-traditional transports for video (e.g., ethernet). In addition, TAD may advantageously enable interfacing with monitors implementing legacy transports such as DisplayPort or HDMI. TAD may accordingly enable transmission of data streams over a variety of transports.

Incorporation of TAD mechanisms and methods may have various advantages. TAD may provide independence from encoded streams by accepting a variety of encoding formats (and different encoding formats may map well to different transports). TAD may also provide generic, fundamental video data streaming constructs that may be mapped onto different transports. TAD may additionally provide video streams that may be natively transported concurrently, along with other non-video streams (e.g., data streams), on the same interface. In various embodiments, TAD may also scale with the performance and/or capabilities of the transport, and may be applicable to very-high-performance transports such as Converged Input/Output (CIO).

In addition, TAD may provide transport-independent video streaming protocol definition supplemented by transport specific adaptation. TAD may also provide generic methods for discover, control, and configuration operations that abstract away from disparate sideband control buses and/or protocols that may be present in legacy interface standards (e.g., Inter-Integrated Circuit (I2C), Display Data Channel (DDC), auxiliary channels, and/or sideband channels). TAD may additionally use interface-independent adaptation of content protection mechanism (e.g., High-bandwidth Digital Copy Protection (HDCP) Interface Independent Adaptation (IIA)), which may facilitate or enable adaptation to both wired and wireless transports. TAD may also provide constructs for heuristics and error handling to facilitate or enable Quality-of-Service (QoS) and flow control over shared transports.

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

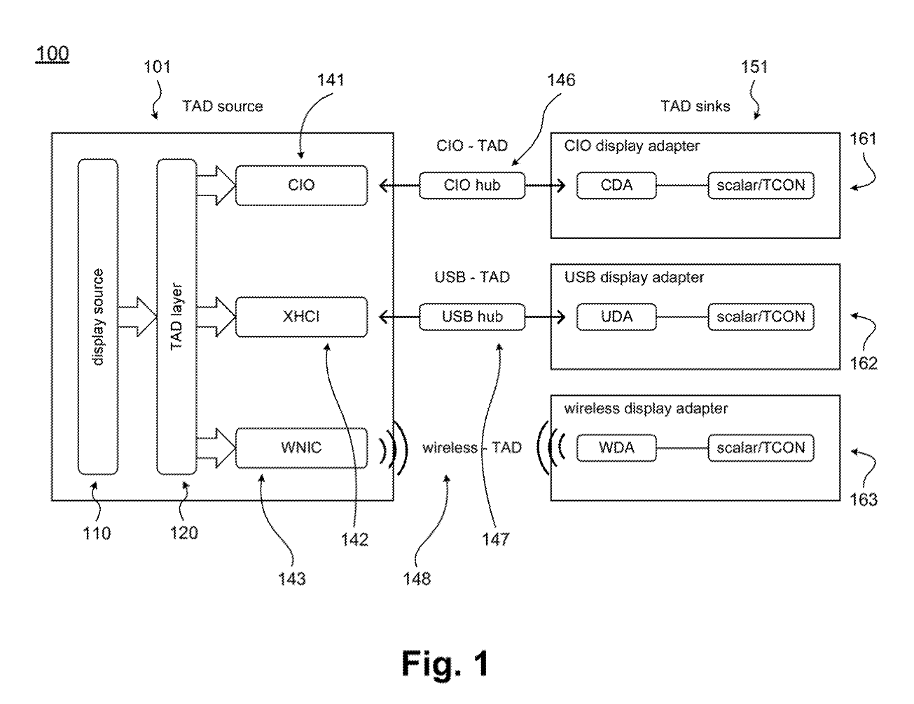

FIG. 1 illustrates an end-to-end flow in devices incorporating TAD mechanisms and methods, in accordance with some embodiments of the disclosure. An end-to-end flow 100 may comprise a TAD source 101, one or more TAD sinks 151, and a respectively corresponding set of protocol-based interfaces through which TAD source 101 may be coupled to TAD sinks 151.

TAD source 101 may comprise a display source 110, a TAD layer 120, and one or more protocol-based interfaces (e.g., a CIO interface 141, an Extensible Host Controller Interface (XHCI) 142, and/or a wireless network interface controller (WNIC) 143). TAD sinks 151 may comprise a first TAD sink 161 (which may be a portion of a CIO display adapter (CDA)), a second TAD sink 162 (which may be a portion of a USB display adapter (UDA)), and a third TAD sink 163 (which may be a portion of a wireless display adapter (WDA)). TAD sinks 151 may also optionally comprise scalar circuitries and/or timing controller circuitries (e.g., TCON circuitries).

The one or more protocol-based interfaces of TAD source 101 may then be coupled to the one or more TAD sinks 151 by one or more transports, such as a CIO-TAD transport 146, a USB-TAD transport 147, and/or a wireless-TAD transport 148.

With respect to FIG. 1, Various transports may be capable of carrying both video traffic and non-video traffic. Various display adaptors (e.g., a CDA, a UDA, and/or a WDA) may be adapters for CIO, USB, and wireless, respectively, any of which may extract a video stream from data over a links and forward it to a TAD receivers (and, potentially, a TCON).

TAD may be a packetized display protocol defined for shared transports. Display streams may be packetized in such a way as to allow for coexistence of display traffic and non-display traffic over a common transport. The TAD protocol may comprise both a data stream and a control stream. The data stream may include pixel data and frame-synchronous metadata, while the control stream may handle transport-agnostic discovery, configuration, notification, and non-frame-synchronous metadata.

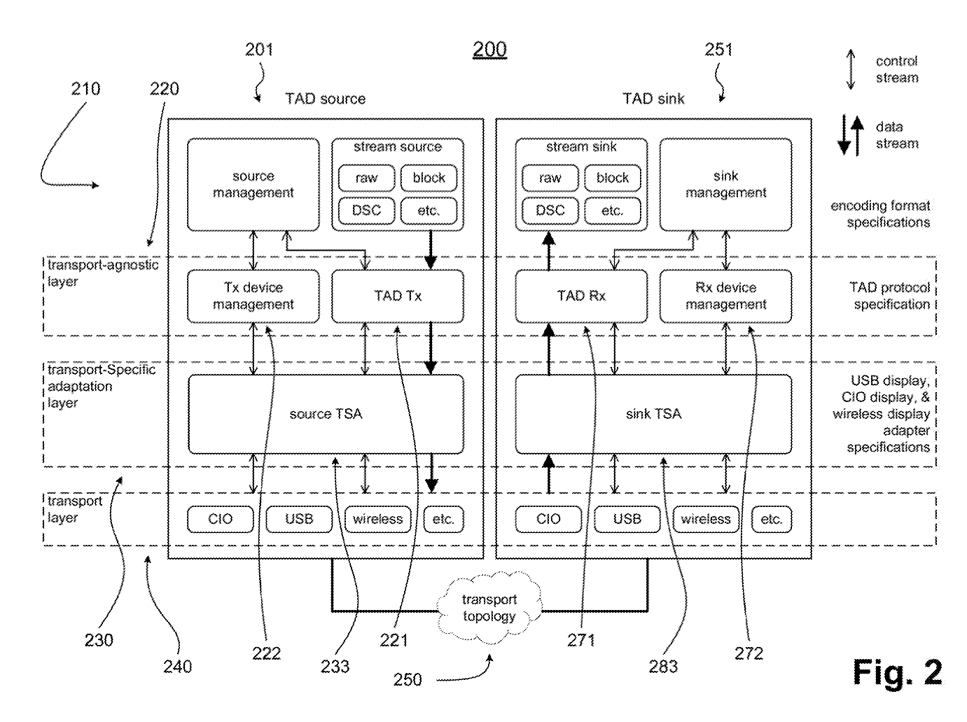

FIG. 2 illustrates a layered architecture comprising a TAD source and a TAD sink, in accordance with some embodiments of the disclosure. An architecture 200 may comprise a TAD source 201 and a TAD sink 251. Architecture 200 may have a component layer 210, a transport-agnostic layer 220, a transport-specific adaptation layer 230, and a transport layer 240. TAD source 201 and TAD sink 251 may have each have portions spanning component layer 210, transport-agnostic layer 220, transport-specific adaptation layer 230, and transport layer 240. (Although depicted as being at the same level within architecture 200, the component in which the circuitries of TAD source 201 in component layer 210 are implemented may be a separate component from a component in which the circuitries of TAD sink 251 in component layer 210 are implemented.)

TAD source 201 may have a source management circuitry and/or a stream source circuitry within component layer 210. TAD source 201 may also have a TAD transmission circuitry 221 and/or a transmission device management circuitry 222 in transport-agnostic layer 220. TAD source 201 may additionally have a source transport-specific adaptation (TSA) circuitry 233 in transport-specific adaptation layer 230. TAD source 201 may also have one or more transport-specific interface circuitries in transport layer 240 (e.g., a CIO interface, a USB interface, a wireless interface, and so on).

TAD sink 251 may have a sink management circuitry and/or a stream sink circuitry within component layer 210. TAD sink 251 may also have a TAD receiving circuitry 271 and/or a receiving device management circuitry 272 in transport-agnostic layer 220. TAD sink 251 may additionally have a sink TSA circuitry 283 in transport-specific adaptation layer 230. TAD sink 251 may also have one or more transport-specific interface circuitries in transport layer 240 (e.g., a CIO interface, a USB interface, a wireless interface, and so on).

TAD source 201 may be in communication with a transport topology 250 via the transport-specific interface circuitries in transport layer 240. TAD sink 251 may also be in communication with transport topology 250 via the transport-specific interface circuitries in transport layer 240. As a result, portions of TAD source 201 in component layer 210 may be in communication with portions of TAD sink 251 in component layer 210, through various transport-specific interface circuitries in transport layer 240, and through the stacks of lower layers in TAD source 201 and TAD sink 251.

In general, TAD source 201 may be operable to transmit streams of data from component layer 210 to various transports in transport topology 250. Within TAD source 201, a source management circuitry of component level 210 may be coupled to transmission device management circuitry 222 and/or TAD transmission circuitry 221 via one or more bidirectional control interfaces. A stream source circuitry of component level 210 may be coupled to TAD transmission circuitry 221 via a unidirectional data interface.

Transmission device management circuitry 222 and/or TAD transmission circuitry 221 may then be coupled to source TSA circuitry 233 via one or more bidirectional control interfaces. TAD transmission circuitry 221 may be coupled to source TSA circuitry 233 via a unidirectional data interface.

Source TSA circuitry 233 may convert streams of data from a transport-agnostic protocol of transport-agnostic layer 220 to transport-specific protocols of transport layer 240. Source TSA circuitry 233 may then be coupled to the transport-specific interface circuitries of transport layer 240 through the transport-specific interface circuitries of transport layer 240, and may thereby transmit streams of data over transport topology 250.

In general, TAD sink 251 may be operable to receive streams of data from various transports in transport topology 250 and provide them to component layer 210. Within TAD source 251, transport topology 250 may be coupled to sink TSA circuitry 283 through the transport-specific interface circuitries of transport layer 240. Sink TSA circuitry 283 may convert streams of data from transport-specific protocols of transport layer 240 to a transport-agnostic protocol of transport-agnostic layer 220.

Sink TSA circuitry 283 may be coupled to TAD receiving circuitry 271 and/or receiving device management circuitry 272 via one or more bidirectional control interfaces. Sink TSA circuitry 283 may be coupled to TAD receiving circuitry 271 via a unidirectional data interface.

Receiving device management circuitry 272 and/or TAD receiving circuitry 271 may be coupled to a sink management circuitry of component level 210 via one or more bidirectional control interfaces. TAD receiving circuitry 271 may be coupled to a stream sink circuitry of component level 210 via a unidirectional data interface.

With respect to FIGS. 1 and 2, packetized streams from a TAD layer may be transmitted over a variety of transports (e.g., a CIO transport, a Thunderbolt™ transport, a USB transport, an ethernet transport, a wireless transport, and so on). A source TSA may enable a TAD to be defined in a transport agnostic manner. In some embodiments, TAD may be defined in conjunction with source TSA layers that may contain policies on how best to use the characteristics of an underlying transport to deliver a video stream to a given TAD sink.

Some embodiments may be designed toward a set of targets for carrying TAD streams. These targets may include: the availability of a high-bandwidth unidirectional data path and a low-bandwidth bidirectional control path; the presence of an ability to transmit data in order to a TAD sink; mechanisms and methods for preventing overflow; and mechanisms and methods for preventing underflow.

Various aspects of TAD may relate to encoding independence. In some embodiments, a TAD source may accept an extensible range of input stream formats, which may include a raw bitstream, a Video Electronics Standards Association (VESA) defined Display Screen Compression (DSC), a block compression scheme (e.g., H.264 and/or H.265), and other encoding formats.

For some embodiments, policies in a stream source circuitry above the TAD transmission circuitry in a TAD source may result in choosing an encoding format based on the nature of the underlying transport. For example, one policy may use block compression formats for a lossy transport such as wireless, and may use a raw, uncompressed bitstream for a less-lossy transport (e.g., a USB transport).

In some embodiments, TAD may facilitate or enable framework constructs for communicating an encoding format thru metadata transmitted as part of stream session setup. For some embodiments, the nature of encoding streamed through a TAD transmission circuitry could change based upon a usage characteristic of the underlying transport. In some embodiments, TAD may define constructs enabling a stream source circuitry to discover a decoding capability of a TAD sink.

Various aspects of TAD may relate to generic video streaming constructs. In some embodiments, TAD may output packetized streams to a source TSA layer circuitry. The packetized streams may contain optionally encoded and/or optionally encrypted video data. Moreover, packet sizes and/or packet structuring may be independent of the underlying transport. In some embodiments, a source TSA layer may packetize a stream further to best match transport capabilities.

For some embodiments, a TAD transmission circuitry may decouple its data output from actual video timing by using through the use of a presentation timestamp (PTS). A PTS in a transport header may build on a transport-specific time base, and (along with source TSA constructs) may enable transmission in a transport-independent manner.

Various aspects of TAD may relate to generic discovery, control, and configuration. In some embodiments, TAD transmission circuitry may define a packetized control plane that is independent of specific transport buses (e.g., I2C, auxiliary channels, or sideband channels). The control plane may be structured as request packets and response packets for generically-defined capability, status, command, and configuration structures that may be mapped to legacy bus-specific downstream operations in a TAD sink. For some embodiments, the TAD transmission circuitry may transmit these control plane packets in-band with a data plane. For some embodiments, the TAD transmission circuitry may transmit these control plane packets out-of-band with a data plane.

Various aspects of TAD may relate to concurrency with non-video streams. In some embodiments, TAD may achieve transport independence by abstracting away from the underlying transport in terms of bandwidth available for a TAD data stream. For some embodiments, TAD streams (which may include video streams) may be transported concurrently with non-video streams (e.g., from protocols other than TAD) on a shared transport, with the source TSA determining the transport constructs to use in order to achieve a desired prioritization. In some embodiments, TAD streams may have exclusive access to an entire transport layer during video transmission.

Various aspects of TAD may relate to content protection. In some embodiments, TAD may incorporate HDCP-IIA to protect video content being transported. Authentication messages defined in HDCP-IIA may be transported as part of TAD packets, which may facilitate or enable them to be transport-independent. HDCP repeater functionality in a TAD sink may enable adaptation to specific downstream interfaces as desired.

For some embodiments, content protection schemes other than HDCP may be used to protect a TAD stream, and a corresponding authentication message may be transmitted in a transport-independent and/or interface-independent manner.

Various aspects of TAD may relate to QoS. For some embodiments, a goal for QoS in TAD may be visual quality. In some embodiments, a goal for QoS in TAD may be low latency.

In some embodiments, TAD may achieve QoS by supplementing information about current bandwidth availability with error reporting from a TAD Sink and/or a TSA layer to refine its heuristics and policies for Quality of Service. For some embodiments, this refinement may be through changing a resolution or a color depth of a bitstream. In some embodiments, this refinement may be re-negotiating one or more operational parameters with a TSA and/or transport layer.

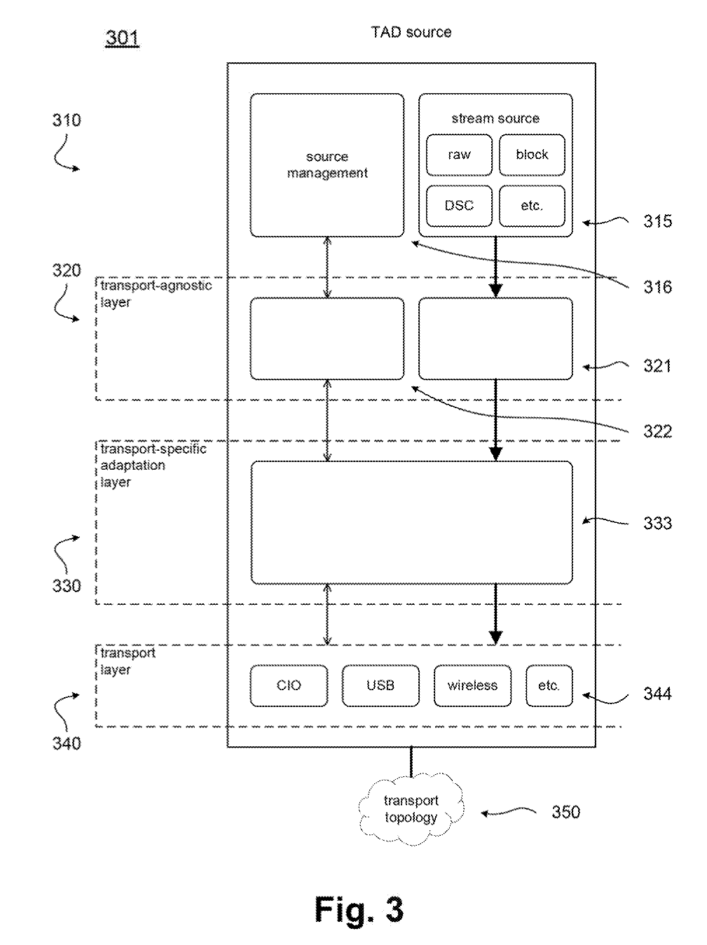

FIG. 3 illustrates an apparatus comprising TAD source mechanisms, in accordance with some embodiments of the disclosure. A TAD source 301 may comprise various circuitries within a component layer 310, a transport-agnostic layer 320, a transport-specific adaptation layer 330, and a transport layer 340. In various embodiments, circuitries and/or aspects of TAD source 301 may be substantially similar to corresponding circuitries and/or aspects of TAD source 201 of FIG. 2. Accordingly, TAD source 301 may comprise various circuitries operable in accordance with TAD source 201 of FIG. 2.

Returning to FIG. 3, transport-agnostic layer 320 may comprise a first circuitry 321, which may include a TAD transmission circuitry, and a second circuitry 322, which may include a transmission device management circuitry and/or part of a TAD transmission circuitry. Transport-specific adaptation layer 330 may comprise a third circuitry 333, which may include part of a source-side transport specific adaptation circuitry. Transport layer 340 may comprise one or more fourth circuitries 344, which may be transport-specific interface circuitries (e.g., a CIO interface, a USB interface, a wireless interface, and so on).

Component layer 310 may comprise a source management circuitry 316 and a stream source circuitry 315. In various embodiments, stream source circuitry 315 may include one or more source-related circuitries (e.g., a raw source circuitry, a block source circuitry, a DSC circuitry, and so on), which may provide component-side interfaces to TAD source 301.

First circuitry 321 may be operable to provide output to a unidirectional data path for carrying a packetized data stream (e.g., the unidirectional data path may be a transmission data path). Second circuitry 322 may be operable to provide output to, and obtain input from, a bidirectional control path for carrying a packetized control stream. The packetized data stream may comprise pixel data traffic and frame-synchronous metadata traffic, and the packetized control stream may comprise frame-asynchronous metadata traffic and control traffic. The unidirectional data path and the bidirectional control path may be coupled to third circuitry 333.

In some embodiments, the data stream may have a first bandwidth, and the control stream may have a second bandwidth, the first bandwidth being greater than the second bandwidth. For some embodiments, the control traffic may comprise discovery traffic, configuration traffic, notification traffic, capability traffic, status traffic, error traffic, and/or command traffic. In some embodiments, the data stream and/or the control stream may be transport-agnostic.

For some embodiments, the unidirectional data path and the bidirectional control path may be coupled to one or more transport-specific interfaces (e.g., through third circuitry 333). In some embodiments, third circuitry 333 may be operable to convert the pixel data traffic, the frame-synchronous metadata traffic, the frame-asynchronous metadata traffic, and/or the control traffic to traffic for the one or more transport-specific interfaces.

For some embodiments, the data stream may be encoded in accordance with an encoding format. In some embodiments, the frame-asynchronous metadata traffic may comprise the encoding format. For some embodiments, the encoding format may be determined based in part upon event discovery information. In some embodiments, the encoding format may be determined based in part upon an identified transport-specific interface for the corresponding data stream.

Accordingly, the various circuitries of TAD source 301 may provide a transport-agnostic interface between component-side circuitries and specific transports of a transport topology 350, at least in part via a unidirectional data transmission path and a bidirectional control path.

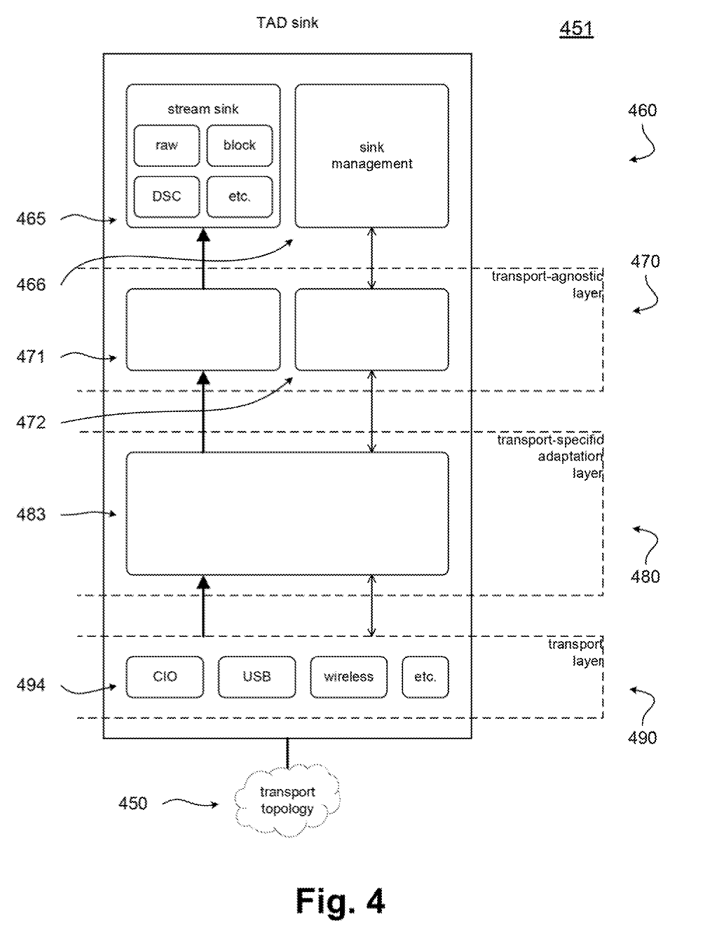

FIG. 4 illustrates an apparatus comprising TAD sink mechanisms, in accordance with some embodiments of the disclosure. A TAD sink 451 may comprise various circuitries within a component layer 460, a transport-agnostic layer 470, a transport-specific adaptation layer 480, and a transport layer 490. In various embodiments, circuitries and/or aspects of TAD sink 451 may be substantially similar to corresponding circuitries and/or aspects of TAD sink 251 of FIG. 2. Accordingly, TAD sink 351 may comprise various circuitries operable in accordance with TAD sink 251 of FIG. 2.

Returning to FIG. 4, transport-agnostic layer 470 may comprise a first circuitry 471, which may include a TAD receiving circuitry, and a second circuitry 472, which may include a transmission device management circuitry and/or part of a TAD receiving circuitry. Transport-specific adaptation layer 480 may comprise a third circuitry 483, which may include part of a sink-side transport specific adaptation circuitry. Transport layer 490 may comprise one or more fourth circuitries 494, which may be transport-specific interface circuitries (e.g., a CIO interface, a USB interface, a wireless interface, and so on).

Component layer 460 may comprise a sink management circuitry 466 and a stream sink circuitry 465. In various embodiments, stream sink circuitry 465 may include one or more sink-related circuitries (e.g., a raw source circuitry, a block source circuitry, a Display Screen Compression (DSC) circuitry, and so on), which may provide component-side interfaces to TAD sink 451.

First circuitry 471 may be operable to obtain input from a unidirectional data path for carrying a packetized data stream (e.g., the unidirectional data path may be a receiving data path). Second circuitry 472 may be operable to obtain input from, and to provide output to, a bidirectional control path for carrying a packetized control stream. The packetized data stream may comprise pixel data traffic and frame-synchronous metadata traffic, and the packetized control stream may comprise frame-asynchronous metadata traffic and control traffic. The unidirectional data path and the bidirectional control path may be coupled to third circuitry 483.

In some embodiments, the data stream may have a first bandwidth, and the control stream has a second bandwidth, the first bandwidth being greater than the second bandwidth. For some embodiments, the control traffic may comprise discovery traffic, configuration traffic, notification traffic, capability traffic, status traffic, error traffic, and/or command traffic. In some embodiments, the data stream and/or the control stream may be transport-agnostic.

For some embodiments, the unidirectional data path and the bidirectional control path may be coupled to one or more transport-specific interfaces (e.g., through third circuitry 483). In some embodiments, third circuitry 483 may be operable to convert traffic for the one or more transport-specific interfaces to the pixel data traffic, the frame-synchronous metadata traffic, the frame-asynchronous metadata traffic, and/or the control traffic.

For some embodiments, the data stream may be encoded in accordance with an encoding format. In some embodiments, the frame-asynchronous metadata traffic may comprise the encoding format. For some embodiments, the encoding format may be determined based in part upon event discovery information. In some embodiments, the encoding format may be determined based in part upon an identified transport-specific interface for the corresponding data stream.

Accordingly, the various circuitries of TAD sink 451 may provide a transport-agnostic interface between component-side circuitries and specific transports of a transport topology 450, at least in part via a unidirectional data receiving path and a bidirectional control path.

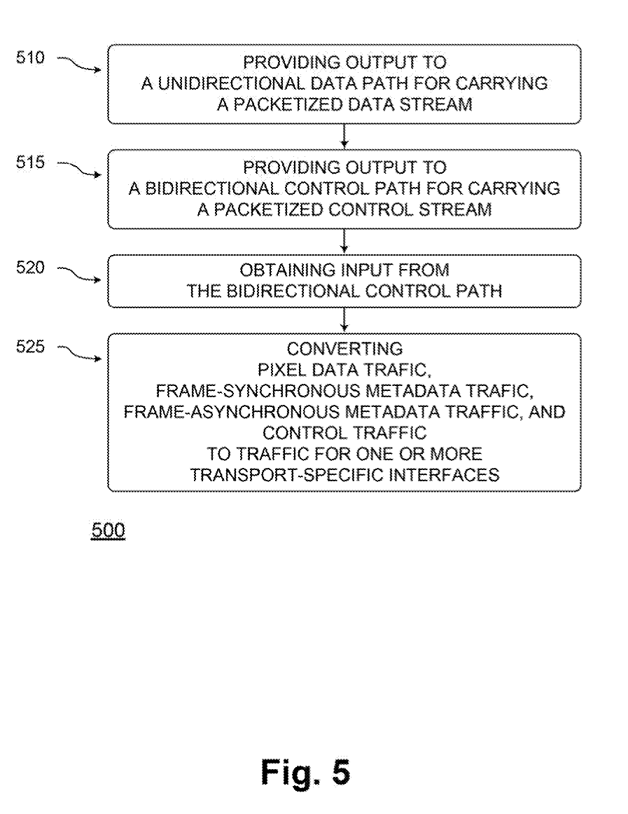

FIG. 5 illustrates a TAD source method, in accordance with some embodiments of the disclosure. A method 500 may comprise a providing 510, a providing 515, and an obtaining 520. In some embodiments, method 500 may also comprise a converting 525. In various embodiments, method 500 may comprise aspects that may be substantially similar to aspects and/or operations of TAD source 201 of FIG. 2. Accordingly, method 500 may comprise operations in accordance with TAD source 201 of FIG. 2.

Returning to FIG. 5, in providing 510, an output may be provided to a unidirectional data path for carrying a packetized data stream. In providing 515, an output may be provided to a bidirectional control path for carrying a packetized control stream. In obtaining 520, an input may be obtained from the bidirectional control path. The packetized data stream may comprise pixel data traffic and frame-synchronous metadata traffic, and the packetized control stream may comprise frame-asynchronous metadata traffic and control traffic.

In some embodiments, the data stream may have a first bandwidth, and the control stream may have a second bandwidth, the first bandwidth being greater than the second bandwidth. The control traffic may comprise discovery traffic, configuration traffic, notification traffic, capability traffic, status traffic, error traffic, and/or command traffic.

For some embodiments, the data stream and the control stream may be transport-agnostic. In some embodiments, the unidirectional data path and/or the bidirectional control path may be coupled to one or more transport-specific interfaces.

In some embodiments, in converting 525, the pixel data traffic, the frame-synchronous metadata traffic, the frame-asynchronous metadata traffic, and/or the control traffic may be converted to traffic for the one or more transport-specific interfaces.

For some embodiments, the data stream may be encoded in accordance with an encoding format. In some embodiments, the frame-asynchronous metadata traffic may comprise the encoding format. For some embodiments, the encoding format may be determined based in part upon event discovery information and/or an identified transport-specific interface for the corresponding data stream.

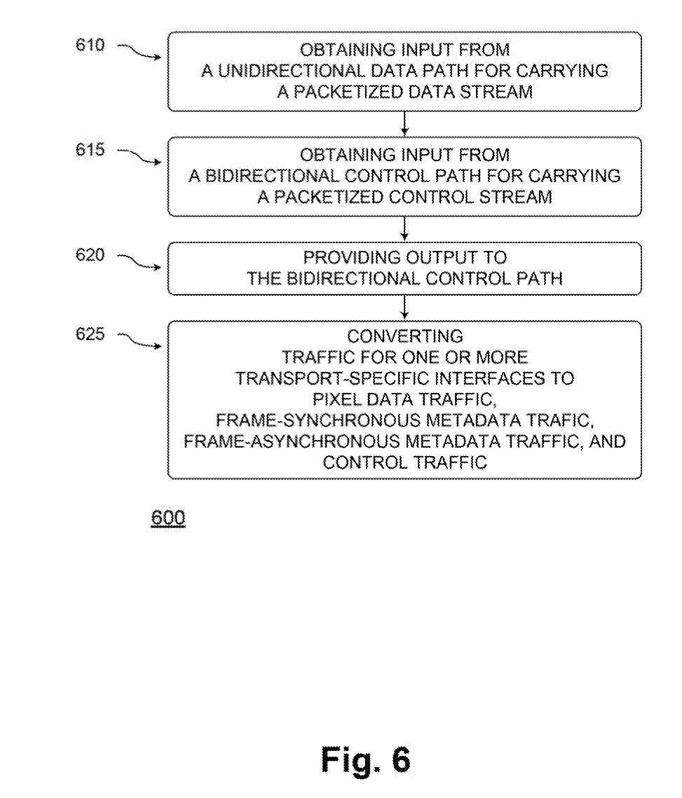

FIG. 6 illustrates a TAD sink method, in accordance with some embodiments of the disclosure. Method 600 may comprise an obtaining 610, an obtaining 615, and a providing 620. In some embodiments, method 600 may comprise a converting 625. In various embodiments, method 600 may comprise aspects that may be substantially similar to aspects and/or operations of TAD sink 251 of FIG. 2. Accordingly, method 600 may comprise operations and/or aspects in accordance with TAD sink 251 of FIG. 2.

Returning to FIG. 6, in obtaining 610, input may be obtained from a unidirectional data path for carrying a packetized data stream. In obtaining 615, input may be obtained from a bidirectional control path for carrying a packetized control stream. In providing 620, output may be provided to the bidirectional control path. The packetized data stream may comprise pixel data traffic and frame-synchronous metadata traffic, and the packetized control stream may comprise frame-asynchronous metadata traffic and control traffic.

In some embodiments, the data stream may have a first bandwidth, and the control stream may have a second bandwidth, the first bandwidth being greater than the second bandwidth. The control traffic may comprise discovery traffic, configuration traffic, notification traffic, capability traffic, status traffic, error traffic, and/or command traffic.

For some embodiments, the data stream and the control stream may be transport-agnostic. In some embodiments, the unidirectional data path and/or the bidirectional control path may be coupled to one or more transport-specific interfaces.

In some embodiments, in converting 625, traffic for the one or more transport-specific interfaces may be converted to the pixel data traffic, the frame-synchronous metadata traffic, the frame-asynchronous metadata traffic, and/or the control traffic.

For some embodiments, the data stream may be encoded in accordance with an encoding format. In some embodiments, the frame-asynchronous metadata traffic may comprise the encoding format. For some embodiments, the encoding format may be determined based in part upon event discovery information and/or an identified transport-specific interface for the corresponding data stream.

Although the actions in the flowchart with reference to FIGS. 5 and 6 are shown in a particular order, the order of the actions can be modified. Thus, the illustrated embodiments can be performed in a different order, and some actions may be performed in parallel. Some of the actions and/or operations listed in FIGS. 5 and 6 are optional in accordance with certain embodiments. The numbering of the actions presented is for the sake of clarity and is not intended to prescribe an order of operations in which the various actions must occur. Additionally, operations from the various flows may be utilized in a variety of combinations.

In some embodiments, an apparatus may comprise means for performing various actions and/or operations of the methods of FIGS. 5 and 6.

Moreover, in some embodiments, machine readable storage media may have executable instructions that, when executed, cause one or more processors to perform an operation comprising a method of FIGS. 5 and 6. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

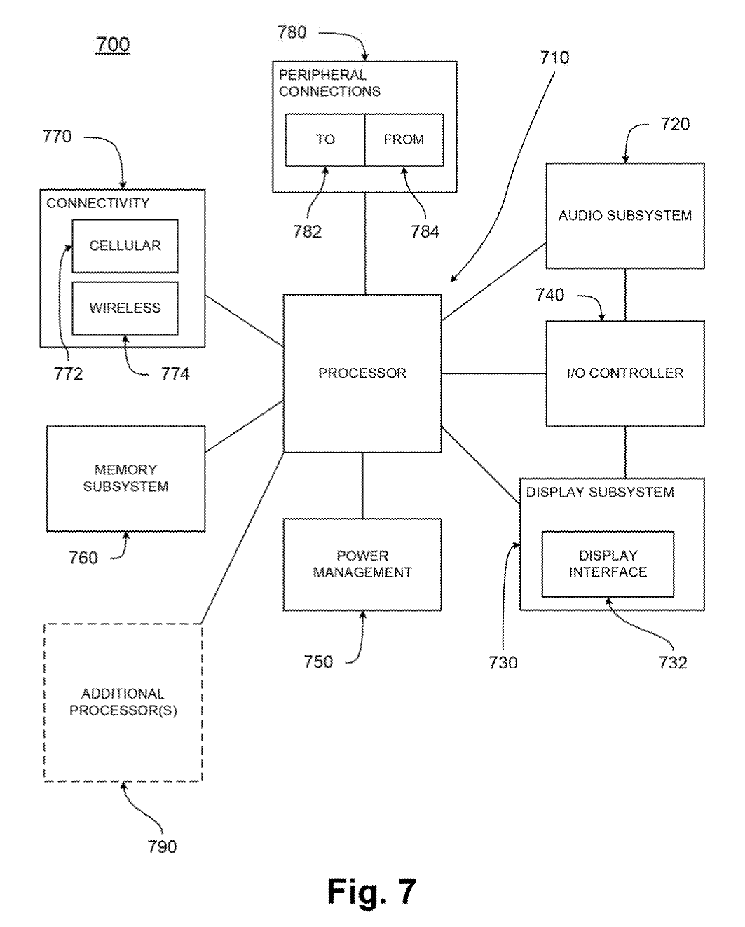

FIG. 7 illustrates a computing device with TAD source mechanisms and/or TAD sink mechanisms, in accordance with some embodiments of the disclosure. Computing device 700 may be a computer system, a System-on-a-Chip (SoC), a tablet, a mobile device, a smart device, or a smart phone with TAD source mechanisms and/or TAD sink mechanisms, in accordance with some embodiments of the disclosure. It will be understood that certain components of computing device 700 are shown generally, and not all components of such a device are shown FIG. 7. Moreover, while some of the components may be physically separate, others may be integrated within the same physical package, or even on the same physical silicon die. Accordingly, the separation between the various components as depicted in FIG. 7 may not be physical in some cases, but may instead be a functional separation. It is also pointed out that those elements of FIG. 7 having the same names or reference numbers as the elements of any other figure can operate or function in any manner similar to that described, but are not limited to such.

In various embodiments, the components of computing device 700 may include any of a processor 710, an audio subsystem 720, a display subsystem 730, an I/O controller 740, a power management component 750, a memory subsystem 760, a connectivity component 770, one or more peripheral connections 780, and one or more additional processors 790. In some embodiments, processor 710 may include TAD source mechanisms and/or TAD sink mechanisms, in accordance with some embodiments of the disclosure. In various embodiments, however, any of the components of computing device 700 may include the TAD source mechanisms and/or TAD sink mechanisms, in accordance with some embodiments of the disclosure. In addition, one or more components of computing device 700 may include an interconnect fabric having a plurality of ports, such as a router, a network of routers, or a Network-on-a-Chip (NoC).

In some embodiments, computing device 700 may be a mobile device which may be operable to use flat surface interface connectors. In one embodiment, computing device 700 may be a mobile computing device, such as a computing tablet, a mobile phone or smart-phone, a wireless-enabled e-reader, or other wireless mobile device. The various embodiments of the present disclosure may also comprise a network interface within 770 such as a wireless interface so that a system embodiment may be incorporated into a wireless device, for example a cell phone or personal digital assistant.

Processor 710 may be a general-purpose processor or CPU (Central Processing Unit). In some embodiments, processor 710 may include one or more physical devices, such as microprocessors, application processors, microcontrollers, programmable logic devices, or other processing means. The processing operations performed by processor 710 may include the execution of an operating platform or operating system on which applications and/or device functions may then be executed. The processing operations may also include operations related to one or more of the following: audio I/O; display I/O; power management; connecting computing device 700 to another device; and/or I/O (input/output) with a human user or with other devices.

Audio subsystem 720 may include hardware components (e.g., audio hardware and audio circuits) and software components (e.g., drivers and/or codecs) associated with providing audio functions to computing device 700. Audio functions can include speaker and/or headphone output as well as microphone input. Devices for such functions can be integrated into computing device 700, or connected to computing device 700. In one embodiment, a user interacts with computing device 700 by providing audio commands that are received and processed by processor 710.

Display subsystem 730 may include hardware components (e.g., display devices) and software components (e.g., drivers) that provide a visual and/or tactile display for a user to interact with computing device 700. Display subsystem 730 may include a display interface 732, which may be a particular screen or hardware device used to provide a display to a user. In one embodiment, display interface 732 includes logic separate from processor 710 to perform at least some processing related to the display. In some embodiments, display subsystem 730 includes a touch screen (or touch pad) device that provides both output and input to a user.

I/O controller 740 may include hardware devices and software components related to interaction with a user. I/O controller 740 may be operable to manage hardware that is part of audio subsystem 720 and/or display subsystem 730. Additionally, I/O controller 740 may be a connection point for additional devices that connect to computing device 700, through which a user might interact with the system. For example, devices that can be attached to computing device 700 might include microphone devices, speaker or stereo systems, video systems or other display devices, keyboard or keypad devices, or other I/O devices for use with specific applications such as card readers or other devices.

As mentioned above, I/O controller 740 can interact with audio subsystem 720 and/or display subsystem 730. For example, input through a microphone or other audio device can provide input or commands for one or more applications or functions of computing device 700. Additionally, audio output can be provided instead of, or in addition to, display output. In another example, if display subsystem 730 includes a touch screen, the display device may also act as an input device, which can be at least partially managed by I/O controller 740. There can also be additional buttons or switches on computing device 700 to provide I/O functions managed by I/O controller 740.

In some embodiments, I/O controller 740 manages devices such as accelerometers, cameras, light sensors or other environmental sensors, or other hardware that can be included in computing device 700. The input can be part of direct user interaction, and may provide environmental input to the system to influence its operations (such as filtering for noise, adjusting displays for brightness detection, applying a flash for a camera, or other features).

Power management component 750 may include hardware components (e.g., power management devices and/or circuitry) and software components (e.g., drivers and/or firmware) associated with managing battery power usage, battery charging, and features related to power saving operation.

Memory subsystem 760 may include one or more memory devices for storing information in computing device 700. Memory subsystem 760 can include nonvolatile memory devices (whose state does not change if power to the memory device is interrupted) and/or volatile memory devices (whose state is indeterminate if power to the memory device is interrupted). Memory subsystem 760 can store application data, user data, music, photos, documents, or other data, as well as system data (whether long-term or temporary) related to the execution of the applications and functions of computing device 700.

Some portion of memory subsystem 760 may also be provided as a non-transitory machine-readable medium for storing the computer-executable instructions (e.g., instructions to implement any other processes discussed herein). The machine-readable medium may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, some embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity component 770 may include a network interface, such as a cellular interface 772 or a wireless interface 774 (so that an embodiment of computing device 700 may be incorporated into a wireless device such as a cellular phone or a personal digital assistant). In some embodiments, connectivity component 770 includes hardware devices (e.g., wireless and/or wired connectors and communication hardware) and software components (e.g., drivers and/or protocol stacks) to enable computing device 700 to communicate with external devices. Computing device 700 could include separate devices, such as other computing devices, wireless access points or base stations, as well as peripherals such as headsets, printers, or other devices.

In some embodiments, connectivity component 770 can include multiple different types of network interfaces, such as one or more wireless interfaces for allowing processor 710 to communicate with another device. To generalize, computing device 700 is illustrated with cellular interface 772 and wireless interface 774. Cellular interface 772 refers generally to wireless interfaces to cellular networks provided by cellular network carriers, such as provided via GSM or variations or derivatives, CDMA (code division multiple access) or variations or derivatives, TDM (time division multiplexing) or variations or derivatives, or other cellular service standards. Wireless interface 774 refers generally to non-cellular wireless interfaces, and can include personal area networks (such as Bluetooth, Near Field, etc.), local area networks (such as Wi-Fi), and/or wide area networks (such as WiMax), or other wireless communication.

Peripheral connections 780 may include hardware interfaces and connectors, as well as software components (e.g., drivers and/or protocol stacks) to make peripheral connections. It will be understood that computing device 700 could both be a peripheral device to other computing devices (via “to” 782), as well as have peripheral devices connected to it (via “from” 784). The computing device 700 may have a “docking” connector to connect to other computing devices for purposes such as managing content on computing device 700 (e.g., downloading and/or uploading, changing, synchronizing). Additionally, a docking connector can allow computing device 700 to connect to certain peripherals that allow computing device 700 to control content output, for example, to audiovisual or other systems.

In addition to a proprietary docking connector or other proprietary connection hardware, computing device 700 can make peripheral connections 780 via common or standards-based connectors. Common types of connectors can include a Universal Serial Bus (USB) connector (which can include any of a number of different hardware interfaces), a DisplayPort or MiniDisplayPort (MDP) connector, a High Definition Multimedia Interface (HDMI) connector, a Firewire connector, or other types of connectors.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

An example provides an apparatus comprising: a first circuitry to provide output to a unidirectional data path for carrying a packetized data stream; and a second circuitry to provide output to, and obtain input from, a bidirectional control path for carrying a packetized control stream, wherein the packetized data stream comprises pixel data traffic and frame-synchronous metadata traffic; and wherein the packetized control stream comprises frame-asynchronous metadata traffic and control traffic.

Some embodiments provide an apparatus wherein the data stream has a first bandwidth, and the control stream has a second bandwidth, the first bandwidth being greater than the second bandwidth.

Some embodiments provide an apparatus wherein the control traffic comprises one or more of: discovery traffic, configuration traffic, notification traffic, capability traffic, status traffic, error traffic, and command traffic.

Some embodiments provide an apparatus wherein the data stream and the control stream are transport-agnostic.

Some embodiments provide an apparatus wherein the unidirectional data path and the bidirectional control path are coupled to one or more transport-specific interfaces.

Some embodiments provide an apparatus comprising: a third circuitry to convert the pixel data traffic, the frame-synchronous metadata traffic, the frame-asynchronous metadata traffic, and the control traffic to traffic for the one or more transport-specific interfaces.

Some embodiments provide an apparatus wherein the data stream is encoded in accordance with an encoding format.

Some embodiments provide an apparatus wherein the frame-asynchronous metadata traffic may comprise the encoding format.

Some embodiments provide an apparatus wherein the encoding format may be determined based in part upon event discovery information.

Some embodiments provide an apparatus wherein the encoding format may be determined based in part upon an identified transport-specific interface for the corresponding data stream.

An example provides a system comprising a memory, a processor coupled to the memory, and a wireless interface for allowing the processor to communicate with another device, the system including the apparatus of various of the examples above.

An example provides a system comprising a memory, a processor coupled to the memory, and a wireless interface for allowing the processor to communicate with another device, the processor including: a first circuitry to provide output to a unidirectional data path for carrying a packetized data stream; and a second circuitry to provide output to, and obtain input from, a bidirectional control path for carrying a packetized control stream, wherein the packetized data stream comprises pixel data traffic and frame-synchronous metadata traffic; and wherein the packetized control stream comprises frame-asynchronous metadata traffic and control traffic.

Some embodiments provide a system wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide a system wherein the data stream and the control stream are transport-agnostic; and wherein the unidirectional data path and the bidirectional control path are coupled to one or more transport-specific interfaces.

Some embodiments provide a system comprising: a third circuitry to convert the pixel data traffic, the frame-synchronous metadata traffic, the frame-asynchronous metadata traffic, and the control traffic to traffic for the one or more transport-specific interfaces.

Some embodiments provide a system wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides a method comprising: providing output to a unidirectional data path for carrying a packetized data stream; providing output to a bidirectional control path for carrying a packetized control stream; and obtaining input from the bidirectional control path, wherein the packetized data stream comprises pixel data traffic and frame-synchronous metadata traffic; and wherein the packetized control stream comprises frame-asynchronous metadata traffic and control traffic.

Some embodiments provide a method wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide a method wherein the data stream and the control stream are transport-agnostic; and wherein the unidirectional data path and the bidirectional control path are coupled to one or more transport-specific interfaces.

Some embodiments provide a method comprising: converting the pixel data traffic, the frame-synchronous metadata traffic, the frame-asynchronous metadata traffic, and the control traffic to traffic for the one or more transport-specific interfaces.

Some embodiments provide a method wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides machine readable storage media having machine executable instructions stored thereon that, when executed, cause one or more processors to perform a method according to various of the examples above.

An example provides an apparatus comprising: means for providing output to a unidirectional data path for carrying a packetized data stream; means for providing output to a bidirectional control path for carrying a packetized control stream; and means for obtaining input from the bidirectional control path, wherein the packetized data stream comprises pixel data traffic and frame-synchronous metadata traffic; and wherein the packetized control stream comprises frame-asynchronous metadata traffic and control traffic.

Some embodiments provide an apparatus wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide an apparatus wherein the data stream and the control stream are transport-agnostic; and wherein the unidirectional data path and the bidirectional control path are coupled to one or more transport-specific interfaces.

Some embodiments provide an apparatus comprising: means for converting the pixel data traffic, the frame-synchronous metadata traffic, the frame-asynchronous metadata traffic, and the control traffic to traffic for the one or more transport-specific interfaces.

Some embodiments provide an apparatus wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides machine readable storage media having machine executable instructions stored thereon that, when executed, cause one or more processors to perform an operation comprising: provide output to a unidirectional data path for carrying a packetized data stream; provide output to a bidirectional control path for carrying a packetized control stream; and obtain input from the bidirectional control path, wherein the packetized data stream comprises pixel data traffic and frame-synchronous metadata traffic; and wherein the packetized control stream comprises frame-asynchronous metadata traffic and control traffic.

Some embodiments provide a machine readable storage media wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide a machine readable storage media wherein the data stream and the control stream are transport-agnostic; and wherein the unidirectional data path and the bidirectional control path are coupled to one or more transport-specific interfaces.

Some embodiments provide a machine readable storage media the operation comprising: convert the pixel data traffic, the frame-synchronous metadata traffic, the frame-asynchronous metadata traffic, and the control traffic to traffic for the one or more transport-specific interfaces.

Some embodiments provide a machine readable storage media wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides an apparatus comprising: a first circuitry to obtain input from a unidirectional data path for carrying a packetized data stream; and a second circuitry to obtain input from, and to provide output to, a bidirectional control path for carrying a packetized control stream, wherein the packetized data stream comprises pixel data traffic and frame-synchronous metadata traffic; and wherein the packetized control stream comprises frame-asynchronous metadata traffic and control traffic.

Some embodiments provide an apparatus wherein the data stream has a first bandwidth, and the control stream has a second bandwidth, the first bandwidth being greater than the second bandwidth.

Some embodiments provide an apparatus wherein the control traffic comprises one or more of: discovery traffic, configuration traffic, notification traffic, capability traffic, status traffic, error traffic, and command traffic.

Some embodiments provide an apparatus wherein the data stream and the control stream are transport-agnostic.

Some embodiments provide an apparatus wherein the unidirectional data path and the bidirectional control path are coupled to one or more transport-specific interfaces.

Some embodiments provide an apparatus comprising: a third circuitry to convert traffic for the one or more transport-specific interfaces to the pixel data traffic, the frame-synchronous metadata traffic, the frame-asynchronous metadata traffic, and the control traffic.

Some embodiments provide an apparatus wherein the data stream is encoded in accordance with an encoding format.

Some embodiments provide an apparatus wherein the frame-asynchronous metadata traffic may comprise the encoding format.

Some embodiments provide an apparatus wherein the encoding format may be determined based in part upon event discovery information.

Some embodiments provide an apparatus wherein the encoding format may be determined based in part upon an identified transport-specific interface for the corresponding data stream.

An example provides a system comprising a memory, a processor coupled to the memory, and a wireless interface for allowing the processor to communicate with another device, the system including the apparatus of various of the examples above.

An example provides a system comprising a memory, a processor coupled to the memory, and a wireless interface for allowing the processor to communicate with another device, the processor including: a first circuitry to obtain input from a unidirectional data path for carrying a packetized data stream; and a second circuitry to obtain input from, and to provide output to, a bidirectional control path for carrying a packetized control stream, wherein the packetized data stream comprises pixel data traffic and frame-synchronous metadata traffic; and wherein the packetized control stream comprises frame-asynchronous metadata traffic and control traffic.

Some embodiments provide a system wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide a system wherein the data stream and the control stream are transport-agnostic; and wherein the unidirectional data path and the bidirectional control path are coupled to one or more transport-specific interfaces.

Some embodiments provide a system comprising: a third circuitry to convert traffic for the one or more transport-specific interfaces to the pixel data traffic, the frame-synchronous metadata traffic, the frame-asynchronous metadata traffic, and the control traffic.

Some embodiments provide a system wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides a method comprising: obtaining input from a unidirectional data path for carrying a packetized data stream; obtaining input from a bidirectional control path for carrying a packetized control stream; and providing output to the bidirectional control path, wherein the packetized data stream comprises pixel data traffic and frame-synchronous metadata traffic; and wherein the packetized control stream comprises frame-asynchronous metadata traffic and control traffic.

Some embodiments provide a method wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide a method wherein the data stream and the control stream are transport-agnostic; and wherein the unidirectional data path and the bidirectional control path are coupled to one or more transport-specific interfaces.

Some embodiments provide a method comprising: converting traffic for the one or more transport-specific interfaces to the pixel data traffic, the frame-synchronous metadata traffic, the frame-asynchronous metadata traffic, and the control traffic.

Some embodiments provide a method wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides machine readable storage media having machine executable instructions stored thereon that, when executed, cause one or more processors to perform a method according to various of the examples above.

An example provides an apparatus comprising: means for obtaining input from a unidirectional data path for carrying a packetized data stream; means for obtaining input from a bidirectional control path for carrying a packetized control stream; and means for providing output to the bidirectional control path, wherein the packetized data stream comprises pixel data traffic and frame-synchronous metadata traffic; and wherein the packetized control stream comprises frame-asynchronous metadata traffic and control traffic.

Some embodiments provide an apparatus wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide an apparatus wherein the data stream and the control stream are transport-agnostic; and wherein the unidirectional data path and the bidirectional control path are coupled to one or more transport-specific interfaces.

Some embodiments provide an apparatus comprising: means for converting traffic for the one or more transport-specific interfaces to the pixel data traffic, the frame-synchronous metadata traffic, the frame-asynchronous metadata traffic, and the control traffic.

Some embodiments provide an apparatus wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An example provides machine readable storage media having machine executable instructions stored thereon that, when executed, cause one or more processors to perform an operation comprising: obtain input from a unidirectional data path for carrying a packetized data stream; obtain input from a bidirectional control path for carrying a packetized control stream; and provide output to the bidirectional control path, wherein the packetized data stream comprises pixel data traffic and frame-synchronous metadata traffic; and wherein the packetized control stream comprises frame-asynchronous metadata traffic and control traffic.

Some embodiments provide a machine readable storage media wherein the data stream has a first bandwidth, and the control stream has a second bandwidth, the first bandwidth being greater than the second bandwidth; and wherein the control traffic comprises one or more of: discovery traffic, configuration traffic, notification traffic, capability traffic, status traffic, error traffic, and command traffic.

Some embodiments provide a machine readable storage media wherein the data stream and the control stream are transport-agnostic; and wherein the unidirectional data path and the bidirectional control path are coupled to one or more transport-specific interfaces.

Some embodiments provide a machine readable storage media the operation comprising: converting traffic for the one or more transport-specific interfaces to the pixel data traffic, the frame-synchronous metadata traffic, the frame-asynchronous metadata traffic, and the control traffic.

Some embodiments provide a machine readable storage media wherein the data stream is encoded in accordance with an encoding format; wherein the frame-asynchronous metadata traffic may comprise the encoding format; and wherein the encoding format may be determined based in part upon at least one of: event discovery information, and an identified transport-specific interface for the corresponding data stream.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An apparatus comprising:
a first circuitry to provide output to a unidirectional data path for carrying a packetized data stream; and
a second circuitry to provide output to, and obtain input from, a bidirectional control path for carrying a packetized control stream,
wherein the packetized data stream comprises pixel data traffic and frame-synchronous metadata traffic; and
wherein the packetized control stream comprises frame-asynchronous metadata traffic and control traffic.

2. The apparatus of claim 1,
wherein the data stream has a first bandwidth, and the control stream has a second bandwidth, the first bandwidth being greater than the second bandwidth.

3. The apparatus of claim 1,
wherein the control traffic comprises one or more of: discovery traffic, configuration traffic, notification traffic, capability traffic, status traffic, error traffic, and command traffic.

4. The apparatus of claim 1,
wherein the data stream and the control stream are transport-agnostic.

5. The apparatus of claim 1,
wherein the unidirectional data path and the bidirectional control path are coupled to one or more transport-specific interfaces.

6. The apparatus of claim 5, comprising:
a third circuitry to convert the pixel data traffic, the frame-synchronous metadata traffic, the frame-asynchronous metadata traffic, and the control traffic to traffic for the one or more transport-specific interfaces.

7. The apparatus of claim 1,
wherein the data stream is encoded in accordance with an encoding format.

8. The apparatus of claim 7,
wherein the frame-asynchronous metadata traffic may comprise the encoding format.

9. The apparatus of claim 8,
wherein the encoding format may be determined based in part upon event discovery information.

10. The apparatus of claim 9,
wherein the encoding format may be determined based in part upon an identified transport-specific interface for the corresponding data stream.

11. A system comprising a memory, a processor coupled to the memory, and a wireless interface for allowing the processor to communicate with another device, the processor including:
a first circuitry to provide output to a unidirectional data path for carrying a packetized data stream; and
a second circuitry to provide output to, and obtain input from, a bidirectional control path for carrying a packetized control stream,
wherein the packetized data stream comprises pixel data traffic and frame-synchronous metadata traffic; and
wherein the packetized control stream comprises frame-asynchronous metadata traffic and control traffic.

12. The system of claim 11,
wherein the data stream has a first bandwidth, and the control stream has a second bandwidth, the first bandwidth being greater than the second bandwidth; and
wherein the control traffic comprises one or more of: discovery traffic, configuration traffic, notification traffic, capability traffic, status traffic, error traffic, and command traffic.

13. The system of claim 11,
wherein the data stream and the control stream are transport-agnostic; and
wherein the unidirectional data path and the bidirectional control path are coupled to one or more transport-specific interfaces.

14. The system of claim 13, comprising:
a third circuitry to convert the pixel data traffic, the frame-synchronous metadata traffic, the frame-asynchronous metadata traffic, and the control traffic to traffic for the one or more transport-specific interfaces.

15. The system of claim 11,
wherein the data stream is encoded in accordance with an encoding format;
wherein the frame-asynchronous metadata traffic may comprise the encoding format; and
wherein the encoding format may be determined based in part upon at least one of: event discovery information, and an identified transport-specific interface for the corresponding data stream.

16. A method comprising:
providing output to a unidirectional data path for carrying a packetized data stream;
providing output to a bidirectional control path for carrying a packetized control stream; and
obtaining input from the bidirectional control path,
wherein the packetized data stream comprises pixel data traffic and frame-synchronous metadata traffic; and
wherein the packetized control stream comprises frame-asynchronous metadata traffic and control traffic.

17. The method of claim 16,
wherein the data stream has a first bandwidth, and the control stream has a second bandwidth, the first bandwidth being greater than the second bandwidth; and
wherein the control traffic comprises one or more of: discovery traffic, configuration traffic, notification traffic, capability traffic, status traffic, error traffic, and command traffic.

18. The method of claim 16,
wherein the data stream and the control stream are transport-agnostic; and
wherein the unidirectional data path and the bidirectional control path are coupled to one or more transport-specific interfaces.

19. The method of claim 18, comprising:
converting the pixel data traffic, the frame-synchronous metadata traffic, the frame-asynchronous metadata traffic, and the control traffic to traffic for the one or more transport-specific interfaces.

20. The method of claim 19,
wherein the data stream is encoded in accordance with an encoding format;
wherein the frame-asynchronous metadata traffic may comprise the encoding format; and
wherein the encoding format may be determined based in part upon at least one of: event discovery information, and an identified transport-specific interface for the corresponding data stream.
